(19) United States
(12) Patent Application Publication
(10) Pub. No.: US 2017/0058158 A1
(43) Pub. Date: Mar. 2, 2017

(54) Sealant, Curing Method thereof, and Article Comprising Cured Sealant

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Dandan MIAO, Beijing (CN); Hongliang YI, Beijing (CN); Wenming REN, Beijing (CN)

(21) Appl. No.: 15/136,259

(22) Filed: Apr. 22, 2016

(30) Foreign Application Priority Data
Sep. 1, 2015 (CN) 201510552484.5

(51) Int. Cl. C09J 133/12; C09J 163/00

(52) U.S. Cl. CPC C09J 133/12; C09J 163/00

(57) ABSTRACT

This invention provides a sealant, a method of curing the sealant, and an article comprising the cured sealant. The sealant comprises a (meth)acrylate, an epoxy resin, a curing agent, and a microwave initiator comprising benzoyl peroxide (BPO) and/or its derivative. In the sealants according to the invention, BPO and its derivatives are each relatively sensitive to microwave energy. When a microwave environment is provided, the activity of BPO or its derivative will be initiated by the microwave energy and the temperature of the sealant will increase, so as to initiate the polymerization of the (meth)acrylate with the curing agent and the polymerization of the epoxy resin with the curing agent to form a solidified sealant.

### FIELD OF THE INVENTION

This invention relates to the field of sealants, and particularly, to a sealant, a method of curing the sealant, and an article comprising the cured sealant.

### BACKGROUND OF THE INVENTION

A display panel generally comprises an array substrate and an opposite substrate. In order to bond them together, a sealant needs to be applied to the non-display region(s) of the array substrate and/or the opposite substrate. Then, the sealant is cured after the array substrate and the opposite substrate are assembled, such that the substrates are bonded together.

In the prior art, sealants may be cured by ultraviolet (UV) light or heating. UV light has a defect of low penetration, and it is difficult for the portions of sealants shaded by the metal leads around the display panel to be cured, as shown in FIG. 1a. On the other hand, thermosetting resins and composite materials thereof in sealants are poor conductors of heat which are characterized by a low heat transfer rate, a large temperature gradient, etc. When a sealant is cured by heating, a phenomenon that the surface of the sealant is cured while its interior is undercured tends to occur, as shown in FIG. 1b. Thus, a higher internal stress develops, and the display panel is prone to peripheral light leakage, sealant overflow, or other defects.

Accordingly, it is a technical problem to be solved in the art to ensure complete curing of sealants.

### SUMMARY OF THE INVENTION

One object of the present invention is to provide a sealant and a curing method to completely cure the sealant.

In order to achieve the above object, there is provided in one aspect of the invention a sealant comprising a (meth)acrylate, an epoxy resin, a curing agent, and a microwave initiator, wherein the microwave initiator comprises benzoyl peroxide (BPO) and/or its derivative.

Preferably, the mass ratio of the (meth)acrylate to the epoxy resin is in a range of 5:4 to 4:3.

Preferably, the content of the microwave initiator in the sealant is not more than 3% by weight (wt %).

Preferably, the sealant further comprises nanosized powder. The content of the nanosized powder in the sealant is preferably in a range of 10 wt % to 15 wt %.

Preferably, the nanosized powder includes nanosized silica powder, nanosized alumina powder, nanosized iron powder, or any combinations thereof.

Preferably, the nanosized silica powder has a particle size within 30±5 nanometer (i.e., 25-35 nm); and/or the nanosized alumina powder has a particle size within 20±5 nm (i.e., 15-25 nm); and/or the nanosized iron powder has a particle size of 20-50 nm. Unless indicated otherwise, the particle size herein refers to average particle size.

Preferably, the sealant further comprises a photoinitiator.

Preferably, the (meth)acrylate is methacrylate.

In another aspect of the invention, there is provided a method of curing a sealant according to the present invention, comprising curing the sealant with energy wave to produce a cured sealant, wherein the energy wave includes microwave.

Preferably, the sealant further comprises a photoinitiator, the energy wave further includes UV light, and the curing method comprises:

irradiating the sealant with the UV light to form a partially cured sealant; and

curing the partially cured sealant with the microwave to produce a completely cured sealant.

Preferably, the duration of irradiating the sealant with the UV light ranges from 50 to 70 seconds (s).

Preferably, the duration of curing the partially cured sealant with the microwave ranges from 15 to 20 minutes (min).

Preferably, the microwave is an electromagnetic wave having a frequency of 2400 MHz to 2600 MHz.

Preferably, a microwave curing apparatus is used to perform the step of curing the sealant with microwave (or the step of curing a UV irradiated sealant with microwave, if the method further comprises the step of irradiating a sealant with UV light to form a partially cured sealant), wherein the microwave curing apparatus comprises a radiation-shielding housing and a microwave generator disposed therein. An article provided with the sealant is disposed in the radiation-shielding housing when the step of microwave curing is performed.

Preferably, the microwave curing apparatus further comprises a supporting frame over the microwave generator, wherein the supporting frame comprises a supporting plate and supporting pins extended upright from the supporting plate. An article provided with the sealant is disposed on the supporting pins when the step of microwave curing is performed.

Preferably, the microwave curing apparatus further comprises a temperature monitoring sensor for measuring the temperature within the radiation-shielding housing.

Preferably, the internal space of the radiation-shielding housing is divided into multiple layers of subspaces, each of which is provided with one microwave generator.

Preferably, the radiation-shielding housing is made of lead plate.

In still another aspect of the invention, there is provided an article comprising a cured sealant according to the present invention.

In the sealants according to the present invention, BPO and its derivatives are each relatively sensitive to microwave energy. When a microwave environment is provided, the activity of BPO or its derivative will be initiated by the microwave energy and the temperature of the sealant will increase, so as to initiate the polymerization of the (meth)acrylate with the curing agent and the polymerization of the epoxy resin with the curing agent to form a solidified sealant.

### BRIEF DESCRIPTION OF THE DRAWINGS

The accompanying drawings, which are provided to facilitate better understanding of the present invention and constitute a portion of the specification, illustrate the invention with reference to the embodiments described hereinafter, but are not intended to limit the invention.

FIG. 1a is a schematic diagram showing curing of a sealant with UV light.

FIG. 1b is a schematic diagram showing curing of a sealant by a heat curing process.

FIG. 2a is a schematic diagram showing the state of a sealant upon UV curing in the process according to the present invention.

FIG. 2b is a schematic diagram showing the state of a sealant upon microwave curing in the process according to the present invention.

FIG. 3 is a schematic diagram showing an exemplary curing apparatus useful for carrying out the curing process according to the present invention.

### LIST OF REFERENCE NUMBERS IN DRAWINGS

100: Array substrate 200: Opposite substrate

300: Sealant 310: Cured sealant

320: Uncured sealant 330: Overflowing sealant

400: Metal lead 500: UV mask

600: Microwave curing apparatus 610: Radiation-shielding housing

620: Microwave generator 630: Supporting frame

631: Supporting pin 632: Supporting plate

640: Temperature monitoring sensor

### DETAILED DESCRIPTION OF CERTAIN EMBODIMENTS

Some embodiments of the present invention will be described in detail with reference to the drawings. It should be understood that the embodiments are described for the purpose of illustrating and explaining the invention, but are not intended to limit the invention.

As used herein, the singular forms “a”, “an”, and “the” include plural referents unless the content clearly dictates otherwise. Thus, for example, reference to a sealant comprising “a (meth)acrylate” includes a mixture of two or more (meth)acrylates used in the sealant.

As used herein, the term “and/or” means one or all of the listed elements, or a combination of any two or more of the listed elements.

Unless otherwise indicated, all numbers expressing feature sizes, amounts, and physical properties used herein are to be understood as being modified in all instances by the term “about”. Accordingly, unless indicated to the contrary, the numerical parameters set forth in the specification and attached claims are approximations that can vary depending upon the desired properties sought to be obtained by those skilled in the art utilizing the teachings disclosed herein. Recitation of numerical ranges by endpoints includes all numbers and ranges subsumed within that range (e.g. 10-15 wt % includes 10 wt %, 11.5 wt %, 12 wt %, 12.75 wt %, 15 wt %, 11.80-14 wt %, etc.).

In one aspect of the invention, there is provided a sealant comprising a (meth)acrylate, an epoxy resin, a curing agent, and a microwave initiator, wherein the microwave initiator comprises BPO and/or its derivative.

In the sealants according to the present invention, BPO and its derivatives are each relatively sensitive to microwave energy. When a microwave environment is provided, the activity of BPO or its derivative will be initiated by the microwave energy and the temperature of the sealant will increase, so as to initiate the polymerization of the (meth)acrylate with the curing agent and the polymerization of the epoxy resin with the curing agent to form a solidified sealant.

It is noted that the (meth)acrylate herein encompasses a class of compounds, rather than a sole compound. The (meth)acrylate includes both acrylate and methacrylate, which may be represented by the following formula:

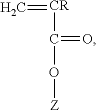

wherein R represents H or methyl, Z represents a residue group derived from a raw compound used to prepare the (meth)acrylate. For example, when the (meth)acrylate is prepared by esterification of an acid/anhydride with an alcohol, Z represents a residue group derived from the alcohol. The (meth)acrylate comprises at least one vinyl group per molecule and can be cured by polymerization.

The (meth)acrylate useful in the present invention includes those commonly used in the art, such as alkyl (meth)acrylate (i.e., Z of the above formula represents an alkyl group), but the invention is not limited thereto. The term “alkyl” refers to a monovalent group that is a radical of an alkane. The alkyl can be linear, branched, cyclic, or combinations thereof and typically contains 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, iso-propyl, n-butyl, iso-butyl, tent-butyl, n-pentyl, n-hexyl, cyclohexyl, n-heptyl, n-octyl, and ethylhexyl. As a specific embodiment, the (meth)acrylate may be methyl methacrylate.

Also, the epoxy resin encompasses a class of compounds, which may be represented by the following formula:

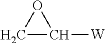

wherein W represents a residue group derived from a raw compound used to prepare the epoxy resin. The epoxy resin comprises at least one epoxy group per molecule and can be cured by polymerization.

The epoxy resin useful in the present invention includes those commonly used in the art. Typically, the epoxy value of the epoxy resin may be in a range of 0.55 to 0.56. The term “epoxy value” refers to the molar amount of the epoxy group per 100g epoxy resin (unit: mol/100g). Liquid epoxy resins are generally suitable for the present invention. Examples of the epoxy resin include, but are not limited to, alicyclic epoxy resins such as glycidyl ethers prepared by reaction of polyhydric phenol (e.g., bisphenol A, bisphenol F, bisphenol S, hexahydrobisphenol A, tetramethyl bisphenol A, diaryl bisphenol A, tetramethyl bisphenol F, etc.) with epichlorohydrin, epoxidized polyolefins, and other known epoxy resins.

The curing agent used in the present invention is not particularly limited, and any curing agent commonly used in the art may be employed as long as it can effectively cure the (meth)acrylate and the epoxy resin. For example, the curing agent may be a latent curing agent. Examples of the latent curing agent are organic hydrazides, which may be represented by the following formula:

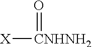

wherein X represents a residue group derived from a raw compound used to prepare the organic hydrazide. The organic hydrazide curing agent comprises at least one hydrazide group per molecule, for example, one, two or more hydrazide group per molecule.

The reaction of the (meth)acrylate with the organic hydrazide curing agent may be represented by the following formula:

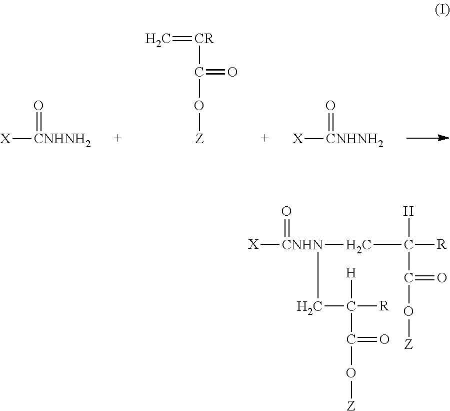

The reaction of the epoxy resin with the organic hydrazide curing agent may be represented by the following formula:

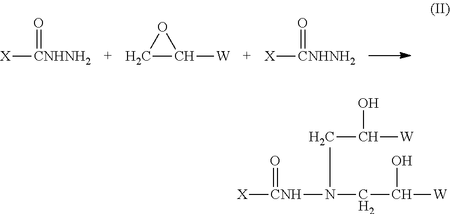

It is readily understood that the above two reactions are polymerization reactions. The above structure (I) is a portion of the final molecular chain produced by the polymerization reaction of the (meth)acrylate with the curing agent, and the above structure (II) is a portion of the final molecular chain produced by the polymerization reaction of the epoxy resin with the curing agent.

The transmission of microwave is less susceptible to the forms of media. In other words, when an array substrate and an opposite substrate are bonded together with the sealant, the metal leads on the array substrate will not block the transmission of microwave. Therefore, microwave can be transmitted uniformly in the sealant to initiate the microwave initiator dispersed in the sealant and increase the temperature of the whole sealant. Thus, the sealant can be cured uniformly and completely.

In the sealant according to the present invention, the (meth)acrylate and the epoxy resin are major components. The sum of the (meth)acrylate and the epoxy resin is greater than 50%, for example, 60%, 70%, 80% or more, by weight of the total sealant. Preferably, the sum of the (meth)acrylate and the epoxy resin comprises 60% to 70% by weight of the total sealant. There is no particular limit to the proportion of the (meth)acrylate to the epoxy resin used in the present invention. For example, the mass ratio of the (meth)acrylate to the epoxy resin may be in a range of 1:1 to 1.4:1. Considering the strength upon UV curing, a certain amount of (meth)acrylate is needed to provide a given strength upon UV curing. Preferably, the mass ratio of the (meth)acrylate to the epoxy resin may be in a range of 5:4 to 4:3.

According to the present invention, BPO and its derivatives are each relatively sensitive to microwave energy, and therefore a small amount of microwave initiator can induce sufficient curing of the sealant in a microwave environment. Preferably, the microwave initiator is present in the sealant in an amount of not more than 3 wt %. As used herein, the derivatives of BPO are organic peroxides derived from BPO.

In order to adjust the fluidity of the sealant and enhance its absorption of microwave, the sealant preferably further comprises nanosized powder. The content of the nanosized powder in the sealant is preferably in a range of 10 wt % to 15 wt %. When the sealant is placed in a microwave environment, the nanosized powder vibrates to improve the transmission of microwave energy, such that the temperature of the sealant can be increased faster. In addition, the sealant becomes less liable to flow after the nanosized powder is added thereto, such that two objects to be bonded (e.g., an array substrate and an opposite substrate) can be positioned more precisely, and the bonding precision can be improved.

As a preferred embodiment of the present invention, the nanosized powder includes nanosized silica powder, nanosized alumina powder, nanosized iron powder, or any combinations thereof.

Furthermore, the nanosized silica powder preferably has a particle size within 30±5 nm. The nanosized alumina powder preferably has a particle size within 20±5 nm. The nanosized iron powder preferably has a particle size of 20-50 nm.

In order to effect curing of the sealant according to the present invention, the sealant may be placed in a microwave environment and cured with the microwave energy.

When the sealant is cured with microwave, the curing time should be strictly controlled to avoid warpage or distortion caused by excessive temperature rising of the panel or the sealant being cured under excessive energy.

In order to obtain a panel having a shape and assembly precision as desired, the sealant may be cured by a combination of light curing and microwave curing. Specifically, the sealant is partially cured first by a light curing process, so as to fix the relative position of the array substrate and the opposite substrate. Then, a microwave curing process is conducted to cure the part of sealant which has not been cured in the light curing process. When the sealant is cured by a combination of light curing and microwave curing, the duration of microwave curing may be shortened appropriately, so as to obtain a relatively even panel.

Accordingly, the sealant may further comprise a photoinitiator, generally a UV photoinitiator. During the light curing stage, the sealant may be irradiated by UV light, such that the photoinitiator can initiate polymerization of the (meth)acrylate with the curing agent to partially cure the sealant.

The partially cured sealant is then placed in a microwave environment, such that the activity of the microwave initiator is excited by microwave energy to induce polymerization and curing of the remaining (meth)acrylate and epoxy resin, respectively.

In another aspect of the invention, there is provided a method of curing a sealant according to the present invention, comprising curing the sealant with energy wave to produce a cured sealant, wherein the energy wave includes microwave.

As described above, the sealant according to the present invention can be completely cured by the energy wave including microwave, because the sealant comprises the microwave initiator whose activity can be initiated by microwave in a microwave environment and the transmission of microwave is less susceptible to media.

As described above, the sealant may further comprise a photoinitiator, generally a UV photoinitiator. Accordingly, the energy wave may further include UV light, and the curing method comprises:

irradiating the sealant with the UV light to form a partially cured sealant; and

curing the partially cured sealant with the microwave to produce a completely cured sealant.

After the sealant is irradiated by the UV light, the activity of the photoinitiator is increased to initiate polymerization and curing reaction of the (meth)acrylate. Thus, the sealant is partially cured upon UV irradiation. The main object of light curing the (meth)acrylate is to primarily attach the array substrate to the opposite substrate and ensure precise assembly of the substrates, as described above.

There is no particular limit to the photoinitiator used in the present invention. Suitable photoinitiator includes any of those commonly used in the art as long as it can effectively initiate photopolymerization of the (meth)acrylate and/or epoxy resin in the sealant. For example, the photoinitiator may be represented by the following formula:

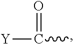

wherein Y represents a group.

The reaction of the (meth)acrylate with the above photoinitiator may be represented by the following formula:

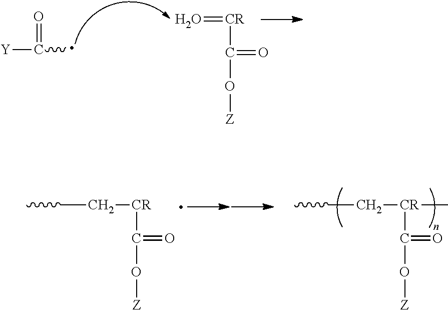

There is no particular limit to the UV curing time in the present invention. Preferably, the duration of irradiating the sealant with the UV light ranges from 50 to 70 seconds. The dosage of UV irradiation may be in a range of 3000-10000 mJ/cm², for example, 5000 mJ/cm².

In order to ensure the evenness of a panel provided with the sealant, the duration of curing the partially cured sealant with the microwave is preferably in a range of 15 to 20 minutes.

In order to achieve a higher curing efficiency and prevent mutual interference of the respective electronic devices, the microwave used in the microwave curing process is preferably an electromagnetic wave having a frequency of 2400 MHz to 2600 MHz.

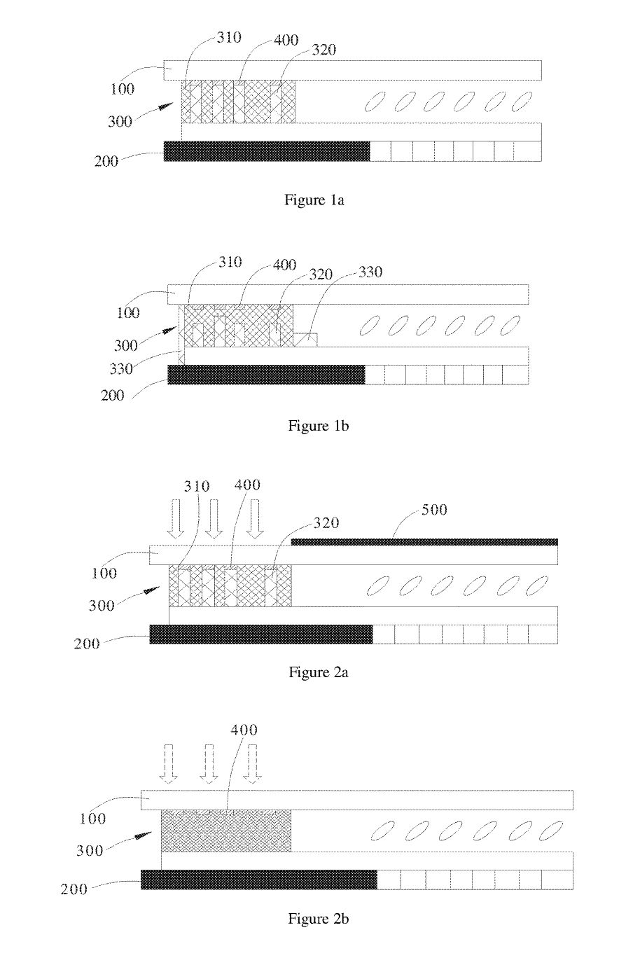

The sealant and the curing method according to the present invention will be described with reference to FIGS. 2a and 2b. In the embodiment as shown in FIGS. 2a and 2b, an array substrate 100 and an opposite substrate 200 are bonded with the sealant.

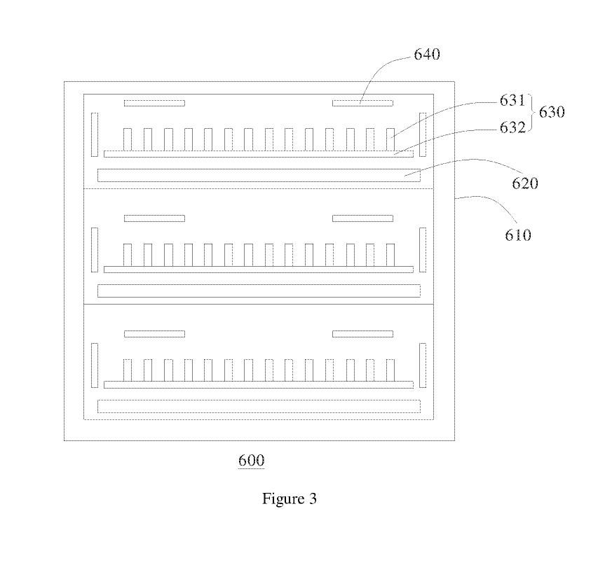

A microwave curing apparatus 600 as shown in FIG. 3 may be used to perform the step of curing the sealant with microwave (or the step of curing a UV irradiated sealant with microwave, if the method further comprises the step of irradiating a sealant with UV light to form a partially cured sealant). As shown in FIG. 3, the microwave curing apparatus 600 comprises a radiation-shielding housing 610 and a microwave generator 620 disposed therein. An article provided with the sealant is disposed in the radiation-shielding housing 610 when the step of microwave curing is performed.

According to the present invention, the microwave curing apparatus 600 is provided with the radiation-shielding housing 610 to protect operators from microwave radiation.

In order to dispose the sealant in a uniform microwave environment, it is preferable that the microwave curing apparatus 600 may further comprise a supporting frame 630. As shown in FIG. 3, the supporting frame 630 comprises a supporting plate 632 and a plurality of supporting pins 631 extended upright from the supporting plate 632, wherein the supporting frame 630 is disposed over the microwave generator 620. An article provided with the sealant is disposed on the supporting pins 631 when the step of microwave curing is performed.

The supporting pins 631 each have a relatively small end surface, such that the contact area between the supporting pins and the article provided with the sealant is small. The supporting plate 632 can be disposed stably over the microwave generator 620.

If the temperature during microwave curing is too high, the strength of the cured sealant will be decreased, and thus the reliability of the final product will be reduced. In order to facilitate controlling of the microwave curing process, the microwave curing apparatus 600 further comprises a temperature monitoring sensor 640 for measuring the temperature within the radiation-shielding housing 610.

When the temperature monitoring sensor 640 measures that the temperature within the radiation-shielding housing 610 exceeds a predetermined value, the microwave generator 620 is controlled to stop emission of microwave or lower the frequency of microwave. According to the present invention, the temperature in the microwave curing apparatus is preferably controlled within 120±3° C., that is, the predetermined value may be 117-123° C. If the temperature in the microwave curing apparatus is higher than 123° C., the frequency of electromagnetic wave emitted from the microwave generator should be decreased. If the temperature in the microwave curing apparatus is lower than 117° C., the frequency of electromagnetic wave emitted from the microwave generator should be increased.

In order to increase the curing efficiency, a plurality of articles provided with the sealant may be placed in one microwave curing apparatus 600. Accordingly, the internal space of the radiation-shielding housing is divided into multiple layers of subspaces, each of which is provided with one microwave generator 620.

As a specific embodiment of the present invention, the radiation-shielding housing 610 is made of lead plate.

First, a sealant 300 according to the present invention is disposed between the array substrate 100 and the opposite substrate 200.

Then, a UV mask 500 is applied to the display area of the array substrate, while the sealant is irradiated with UV light (as shown by the hollow arrows in FIG. 2a). The sealant in the regions other than those shaded by the metal leads 400 is cured, as shown in FIG. 2a. After the UV irradiation, sealant 300 comprises cured sealant 310 and uncured sealant 320. The cured sealant 310 can maintain the relative position of the array substrate 100 and the opposite substrate 200.

At last, the array substrate and the opposite substrate subjected to UV irradiation are placed in a microwave curing apparatus. As shown in FIG. 2b, the UV irradiated sealant is subjected to microwave curing with electromagnetic wave having a certain frequency (e.g., 2455 MHz) (as shown by the dashed hollow arrows in FIG. 2b). Finally, the sealant which has not been cured in the UV curing process also undergoes curing reaction. After completion of microwave curing, the sealant is fully cured, and the array substrate 100 and the opposite substrate 200 are firmly bonded together.

In still another aspect of the invention, there is provided an article comprising a cured sealant according to the present invention. The article may be a display device comprising an array substrate and an opposite substrate bonded together by the cured sealant. The display device may be, for example, a display panel such as a liquid crystal display panel, OLED panel, etc.

The technical features or elements of the respective aspects and embodiments of the present invention can be combined with each other.

### EXAMPLES

The materials and apparatus used in the Example and Comparative Examples are described in Table 1 below. It is noted that materials and apparatus available from other sources can be used as well.

TABLE 1

| Material/Apparatus | Description |
|---|---|
| Methyl methacrylate | Lizhe Chemical Co., Ltd., Shanghai, China |
| Bisphenol A epoxy resin | E-55(616), Southern resin company, Jiangsu, |
| | China |
| Hydrazine acetate | Xinmingtai Chemical Co., Ltd., Hubei, China |
| Benzoyl peroxide | The First chemical reagent factory, Shanghai, |
| | China |
| Acetophenone | Feiyun Chemical Co., Ltd., Jiangyin, China |
| Nanosized silica | SP30, Longhua Chemical Co., Ltd., Tianjin, |
| (particle size: 25-35 nm) | China |
| Nanosized alumina | DK410-1, DK Nano technology Co., Ltd, |
| (α-Al₂O₃, | Beijing, China |
| particle size: 15-25 nm) | |
| Microwave curing | GJWB2S-3H, Gaojin Microwave Technology |
| apparatus | Co., Ltd., Nanjing, China |

Each of the sealants of the Example and Comparative Examples was prepared by mixing the materials with the composition as shown in Table 2 below (pbw, abbreviation of “part by weight”), and then was disposed between an array substrate and an opposite substrate. Subsequently, in Example 1 (Ex. 1), a UV mask was applied to the display area of the array substrate, and the sealant was irradiated with UV light having a wavelength of 350 nm at a dosage of 5000 mJ/cm² for 70 seconds. Then, the array substrate and the opposite substrate subjected to the UV irradiation were placed in a microwave curing apparatus to further cure the UV irradiated sealant by microwave having a frequency of 2400 MHz for 20 minutes with the temperature set at 120° C. In Comparative Example 1 (CE 1), the same UV irradiation as described in Example 1 was performed without any further curing process, and the resultant sample was directly inspected as described hereinafter. In Comparative Example 2 (CE 2), the sealant was cured only by heating in an oven for 70 minutes with the temperature set at 120° C. In Comparative Example 3 (CE 3), the same UV irradiation as described in Example 1 was performed, and then the array substrate and the opposite substrate subjected to the UV irradiation were placed in an oven to perform the same heating curing as described in CE 2.

TABLE 2

| Example No. | | Ex. 1 | CE 1 | CE 2 | CE 3 |
|---|---|---|---|---|---|
| Sealant | Methyl methacrylate, pbw | 35 | 35 | 35 | 35 |
| composition | Bisphenol A epoxy resin, pbw | 25 | 25 | 25 | 25 |
| | Hydrazine acetate, pbw | 10 | 13 | 13 | 13 |
| | Acetophenone, pbw | 2 | 2 | 2 | 2 |
| | Benzoyl peroxide, pbw | 3 | — | — | — |
| | Nanosized silica, pbw | 10 | 10 | 10 | 10 |
| | Nanosized alumina, pbw | 15 | 15 | 15 | 15 |
| UV | UV wavelength, nm | 350 | 350 | — | 350 |
| irradiation | UV energy, mJ/cm² | 5000 | 5000 | — | 5000 |
| | UV irradiation time, s | 70 | 70 | — | 70 |
| Microwave | Microwave frequency, MHz | 2400 | — | — | — |
| curing | Microwave curing | 120 | — | — | — |
| | temperature, ° C. | | | | |
| | Microwave curing time, min | 20 | — | — | — |
| Heat curing | Heating temperature, ° C. | — | — | 120 | 120 |
| | Heating time, min | — | — | 70 | 70 |

The samples prepared by the Example and Comparative Examples were visually inspected, respectively. It was found that CE 1, which was subjected only to UV curing, exhibited a large area of peripheral sealant overflow as the portions of sealants shaded by the metal leads around the display panel were not cured. CE 2, which was subjected only to heat curing, also exhibited a large area of peripheral sealant overflow as the surface of the sealant was cured while its interior was undercured to build up a higher internal stress. CE 3, which was subjected to both UV irradiation and heat curing, still exhibited sealant overflow in a large area shaded by metal. In contrast, in the Example of the present invention which was subjected to both UV irradiation and microwave curing, the sealant of the resultant display panel was completely cured, and the array substrate and the opposite substrate were firmly bonded together, without peripheral sealant overflow.

It is appreciated that the above embodiments and examples are merely exemplary embodiments employed to illustrate the principles of the present invention, but the present invention is not limited thereto. Those of ordinary skill in the art may make various changes and improvements without departing from the spirit and essence of the present invention, and such variations and modifications are also encompassed in the scope of the present invention.

1. A sealant characterized by comprising a (meth)acrylate, an epoxy resin, a curing agent, and a microwave initiator, wherein the microwave initiator comprises benzoyl peroxide and/or its derivative.

2. The sealant according to claim 1, wherein the mass ratio of the (meth)acrylate to the epoxy resin is in a range of 5:4 to 4:3.

3. The sealant according to claim 1, wherein the content of the microwave initiator in the sealant is not more than 3 wt %.

4. The sealant according to claim 1, wherein the sealant further comprises nanosized powder in an amount of 10% to 15% by weight of the sealant.

5. The sealant according to claim 4, wherein the nanosized powder includes nanosized silica powder, nanosized alumina powder, nanosized iron powder, or any combinations thereof.

6. The sealant according to claim 5, wherein the nanosized silica powder has a particle size of 25-35 nm; and/or the nanosized alumina powder has a particle size of 15-25 nm; and/or the nanosized iron powder has a particle size of 20-50 nm

7. The sealant according to claim 1, wherein the sealant further comprises a photoinitiator.

8. The sealant according to claim 1, wherein the sum of the (meth)acrylate and the epoxy resin comprises 60% to 70% by weight of the sealant.

9. A method of curing a sealant comprising a (meth)acrylate, an epoxy resin, a curing agent, and a microwave initiator, wherein the microwave initiator comprises benzoyl peroxide and/or its derivative, characterized in that the method comprises:
curing the sealant with energy wave to produce a cured sealant, wherein the energy wave includes microwave.

10. The method according to claim 9, wherein the sealant further comprises a photoinitiator and the energy wave further includes UV light, and wherein the curing method comprises:
irradiating the sealant with the UV light to form a partially cured sealant; and
curing the partially cured sealant with the microwave to produce a completely cured sealant.

11. The method according to claim 10, wherein the duration of irradiating the sealant with the UV light ranges from 50 to 70 seconds

12. The method according to claim 10, wherein the duration of curing the partially cured sealant with the microwave ranges from 15 to 20 minutes.

13. The method according to claim 9, wherein the microwave is an electromagnetic wave having a frequency of 2400 MHz to 2600 MHz.

14. The method according to claim 9, wherein a microwave curing apparatus is used to perform curing of the sealant with the microwave, wherein the microwave curing apparatus comprises a radiation-shielding housing and a microwave generator disposed therein, and wherein an article provided with the sealant is disposed in the radiation-shielding housing when the microwave curing is performed.

15. The method according to claim 14, wherein the microwave curing apparatus further comprises a supporting frame over the microwave generator, wherein the supporting frame comprises a supporting plate and supporting pins extended upright from the supporting plate, and wherein the article provided with the sealant is disposed on the supporting pins when the microwave curing is performed.

16. The method according to claim 14, wherein the microwave curing apparatus further comprises a temperature monitoring sensor for measuring the temperature within the radiation-shielding housing.

17. The method according to claim 14, wherein the internal space of the radiation-shielding housing is divided into multiple layers of subspaces, each of which is provided with one microwave generator.

18. The method according to claim 14, wherein the radiation-shielding housing is made of lead plate.

19. An article comprising a cured sealant, characterized in that the sealant comprises a (meth)acrylate, an epoxy resin, a curing agent, and a microwave initiator, wherein the microwave initiator comprises benzoyl peroxide and/or its derivative.

20. The article according to claim 19, wherein the sealant further comprises a photoinitiator and/or nanosized powder.
